(19) United States
(12) Patent Application Publication
(10) Pub. No.: US 2006/0048723 A1
(43) Pub. Date: Mar. 9, 2006

(54) Shock absorbing safety harness

(76) Inventors: Bradley A. Rohlf, North St. Paul, MN (US); Travis P. Betcher, Goodhue, MN (US)

Correspondence Address: IPLM GROUP, P.A., POST OFFICE BOX 18455, MINNEAPOLIS, MN, 55418, US

(21) Appl. No.: 10/935,697

(22) Filed: Sep. 7, 2004

(51) Int. Cl. A62B 35/00

(52) U.S. Cl. 119/857

(57) ABSTRACT

A shock absorbing device includes first and second straps, first and second connectors, and shoulder straps of a safety harness. The first strap has first and second connecting ends and an intermediate portion between the connecting ends. The second strap has first and second segments at one end and an interconnected portion extending toward an opposite end. The first segment is operatively connected to the first connecting end, and the second segment is operatively connected to the second connecting end. The first connector is operatively connected to the shoulder straps and to the first connecting end thereby interconnecting the safety harness and the first strap. The second connector is operatively connected to the second connecting end. The connectors are proximate the one end and the intermediate portion and the interconnected portion extend in a downward direction from the connectors.

### BACKGROUND OF THE INVENTION

1. Field of the Invention

The present invention relates to a shock absorbing safety harness, and more specifically, to a shock absorber incorporated into a safety harness.

2. Description of the Prior Art

Shock absorbing devices, commonly referred to as shock absorbers, are well known in the art of fall arrest equipment. Shock absorbers are intended to be used as part of a personal fall arrest system. A shock absorber dissipates fall energy and limits fall arrest forces transferred to the body of a user. In other words, the shock absorber reduces the force of a fall on the user of the shock absorber thereby reducing the risk of injury from a fall. A typical shock absorber is of relatively simple construction and utilizes a tearing action to absorb the force of the fall as the fall of the user is arrested. Examples of such shock absorbers are disclosed in U.S. Pat. Nos. 4,538,702 and 5,174,410. A shock absorber of this type is typically used in combination with a safety harness donned by the user and a lanyard interconnecting the safety harness and an anchorage point. Therefore, there are several components used in a typical fall protection and fall arrest system, and there is a need to utilize a shock absorbing device with a safety harness in a relatively simple, easy to use manner. This need is addressed by the present invention.

### SUMMARY OF THE INVENTION

A preferred embodiment shock absorbing device includes a safety harness, a first strap, a second strap, a first connector, and a second connector. The safety harness has shoulder straps. The first strap has a first connecting end, a second connecting end, and an intermediate portion. The first connecting end and the second connecting end are at opposite ends of the first strap with the intermediate portion between the first connecting end and the second connecting end. The second strap has a first segment, a second segment, and an interconnected portion. The first segment and the second segment are at one end of the second strap and the interconnected portion extends toward an opposite end of the second strap. The first segment is operatively connected to the first strap proximate the first connecting end, and the second segment is operatively connected to the first strap proximate the second connecting end. The first connecting end and the second connecting end are positioned proximate the one end and the intermediate portion extends toward the opposite end. The first connector is operatively connected to the shoulder straps and to the first connecting end thereby interconnecting the safety harness and the first strap. The second connector is operatively connected to the second connecting end. The first connector and the second connector are positioned proximate the one end and the intermediate portion and the interconnected portion extend in a downward direction therefrom.

Another preferred embodiment shock absorber operatively connected to shoulder straps of a safety harness includes a first strap, a second strap, a harness connector, and a D-ring. The first strap has a first connecting end, a second connecting end, and an intermediate portion. The first connecting end and the second connecting end are at opposite ends of the first strap with the intermediate portion between the first connecting end and the second connecting end. The second strap has a first segment, a second segment, and an interconnected portion. The first segment and the second segment are at one end of the second strap and the interconnected portion extends toward an opposite end of the second strap. The first segment is operatively connected to the first strap proximate the first connecting end, and the second segment is operatively connected to the first strap proximate the second connecting end. The first connecting end and the second connecting end are positioned proximate the one end and the intermediate portion extends toward the opposite end. The harness connector is operatively connected to the shoulder straps and to the first connecting end thereby interconnecting the safety harness and the first strap. The D-ring is operatively connected to the second connecting end. The harness connector and the D-ring are positioned proximate the one end and the intermediate portion and the interconnected portion extend in a downward direction relative to the harness connector and the D-ring.

Another preferred embodiment dorsal D-ring shock absorber assembly for use with a safety harness having shoulder straps criss-crossing and overlapping in divergent fashion at a junction proximate a back of the safety harness includes a shock absorber, a harness connector, and a dorsal D-ring. The shock absorber has a first strap and a second strap. The first strap has a first connecting end, a second connecting end, and an intermediate portion. The first connecting end and the second connecting end are at opposite ends of the first strap with the intermediate portion between the first connecting end and the second connecting end. The second strap has a first segment, a second segment, and an interconnected portion. The first segment and the second segment are at one end of the second strap and the interconnected portion extends toward an opposite end of the second strap. The first segment is operatively connected to the first strap proximate the first connecting end, and the second segment is operatively connected to the first strap proximate the second connecting end. The first connecting end and the second connecting end are positioned proximate the one end and the intermediate portion extends toward the opposite end. The harness connector is operatively connected to the shoulder straps proximate the junction and to the first connecting end thereby interconnecting the safety harness and the first strap. The dorsal D-ring is operatively connected to the second connecting end. The harness connector and the D-ring are positioned proximate the one end and the intermediate portion and the interconnected portion extend in a downward direction relative to the harness connector and the D-ring.

Another preferred embodiment shock absorbing device includes a safety harness having shoulder straps, a strap, a first connector, and a second connector. The strap has a first connecting end, a second connecting end, and an interconnected portion. The first connecting end and the second connecting end are proximate one end of the strap and the interconnected portion extends toward an opposite end of the strap. The first connector is operatively connected to the shoulder straps and to the first connecting end thereby interconnecting the safety harness and the strap. The second connector is operatively connected to the second connecting end, wherein the first connector and the second connector are positioned proximate the one end and the interconnected portion extends in a downward direction therefrom.

### BRIEF DESCRIPTION OF THE DRAWINGS

FIG. 1 is a side view of a prior art shock absorber and a cross section of a sleeve in which the shock absorber is stored;

FIG. 2 is a side view of the prior art shock absorber shown in FIG. 1 partially folded without the sleeve;

FIG. 3 is a rear view of a shock absorber stored in a sleeve incorporated into a safety harness constructed according to the principles of the present invention;

FIG. 4 is a side view of the shock absorber stored in the sleeve operatively connected to the shoulder straps of the safety harness shown in FIG. 3;

FIG. 5 is a side view of the shock absorber shown in FIG. 4 without the sleeve;

FIG. 6 is a side view of the sleeve shown in FIG. 4;

FIG. 7 is a rear view of the shock absorber incorporated into the safety harness shown in FIG. 3 unfolded and without the sleeve;

FIG. 8 is a side view of the shock absorber shown in FIG. 7;

FIG. 9 is a front view of the shock absorber shown in FIG. 7;

FIG. 10 is a side view of the shock absorber shown in FIG. 7 with the components separated;

FIG. 11 is a rear view of a shoulder strap connector of the shock absorber shown in FIG. 3 operatively connected to the shoulder straps of the safety harness;

FIG. 12 is a front view of a D-ring of the shock absorber shown in FIG. 3; and

FIG. 13 is a front view of the shoulder strap connector shown in FIG. 11.

### DETAILED DESCRIPTION OF A PREFERRED EMBODIMENT

A preferred embodiment shock absorbing safety harness constructed according to the principles of the present invention includes a shock absorber designated by the numeral 200 and a safety harness designated by the numeral 300 in the drawings. The shock absorber 200 is configured and arranged to be operatively connected to the safety harness 300. It is recognized that although only one type of safety harness is shown in the drawings for illustrative purposes, the shock absorber 200 may be used with any suitable type of safety harness known in the art.

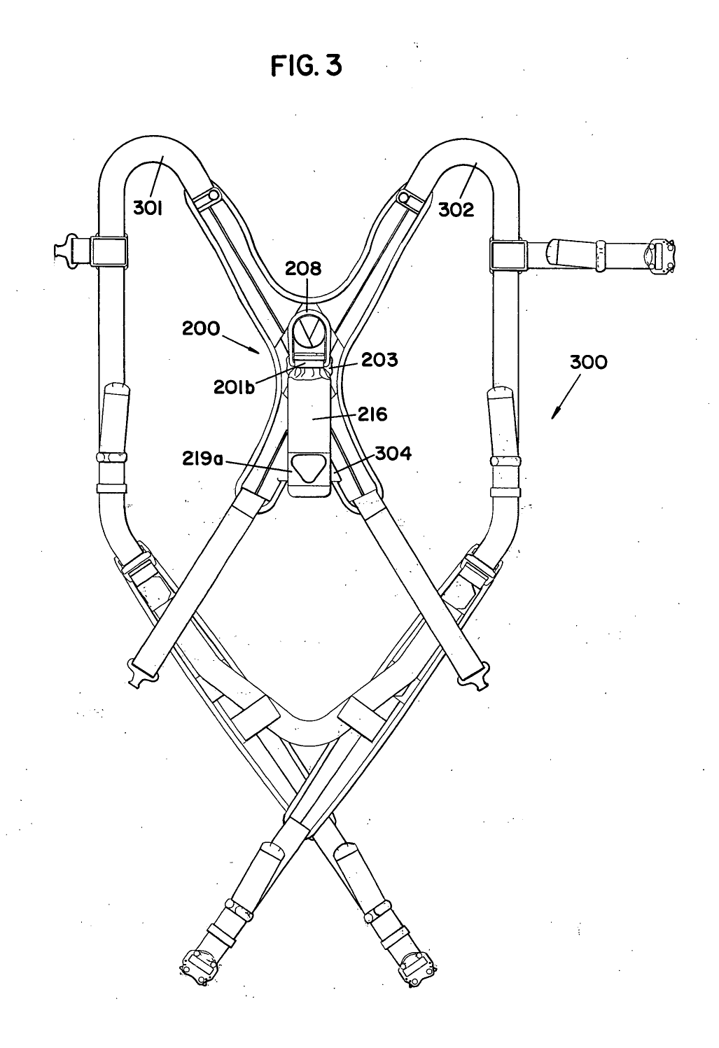

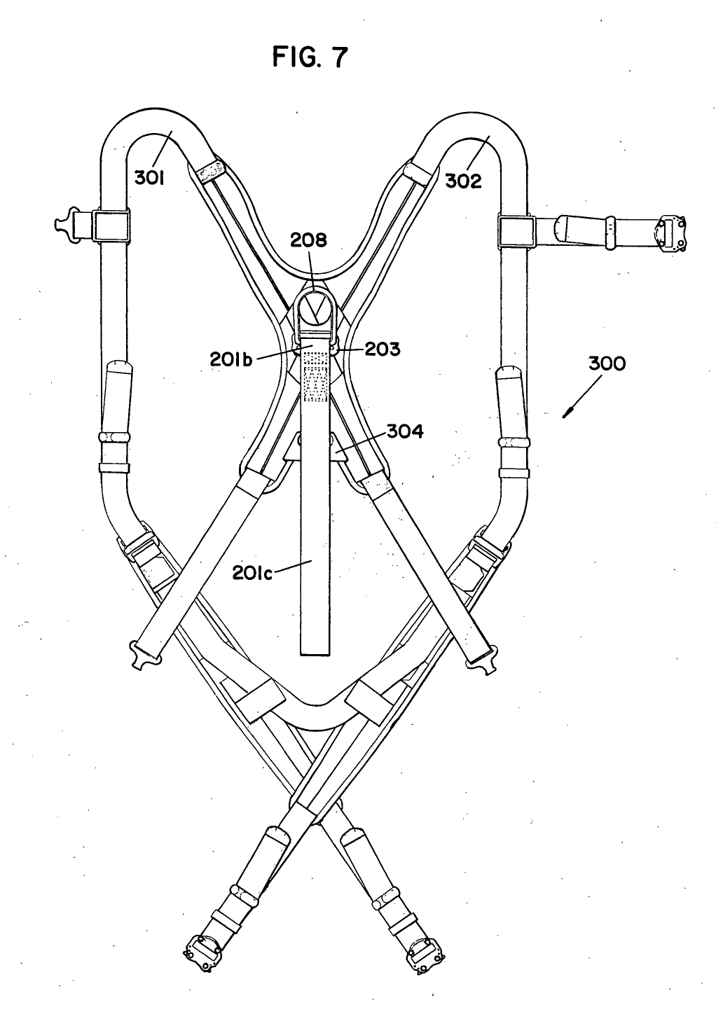

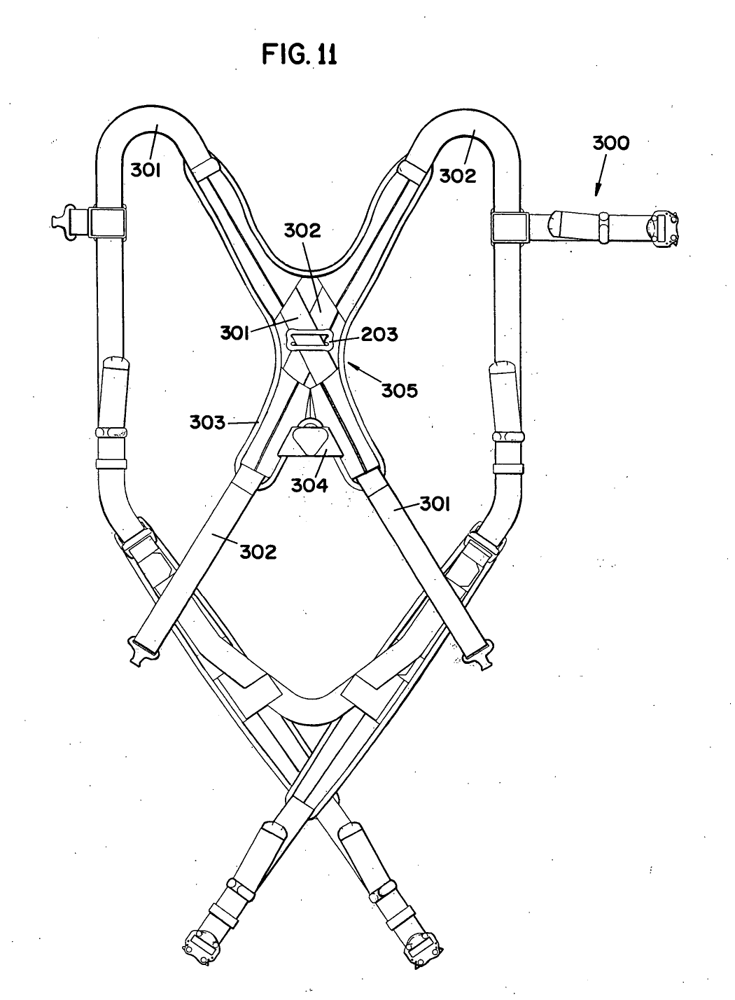

FIGS. 3, 7, and 11 each show a rear view of the safety harness 300 and a front view of the shock absorber 200. The safety harness 300 is generally of the type of safety harness disclosed in U.S. patent application Ser. No. 10/819,035, which is incorporated by reference herein. The safety harness 300 includes a first shoulder strap 301 and a second shoulder strap 302 that criss-cross and overlap in divergent fashion at a junction in the back of the safety harness 300. A removable padding assembly 303 includes an access area 305 proximate the junction of the straps 301 and 302 in the back of the safety harness 300 and a connector strap 304 interconnecting the portions of the removable padding assembly 303 and the portions of the straps 301 and 302 below the access area 305. The access area 305 allows access to the junction of the straps 301 and 302.

The shock absorber 200 includes a strap 201, a shock absorbing strap 202, a harness connector 203, a D-ring 208, and a releasable sleeve 216 in which the straps 201 and 202 are folded and stored. The straps 201 and 202 are preferably made of a nylon or a polyester webbing material. The strap 201 includes a first connecting end 201a, a second connecting end 201b, and an intermediate portion 201c. The strap 201 should have a strength of greater than 5,000 pounds to comply with ANSI requirements. The strap 202 includes a first segment 202a, a second segment 202b, and an intermediate portion 202c. The strap 202 should have a strength sufficient to perform the shock absorbing function, preferably approximately 900 pounds. It is recognized that other types of shock absorbing straps or devices known in the art could be used. For example, rather than having two separate straps 201 and 202, one strap could be used to perform the functions of both straps 201 and 202. The one strap would perform the shock absorbing function of strap 202 but not separate fully as strap 201.

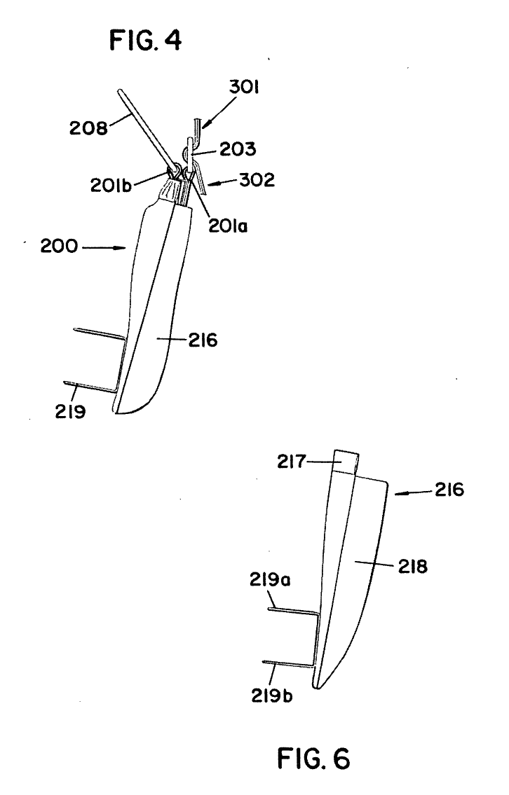

With reference to FIG. 13, the harness connector 203 is preferably a rectangular plate member made of steel and includes a first opening 204, a second opening 205, and a bar portion 206 separating the first opening 204 and the second opening 205. The openings 204 and 205 are configured and arranged to engage the shoulder straps 301 and 302 of the safety harness 300 as is well known in the art. More particularly, the shoulder straps 301 and 302 are inserted through the back of the first opening 204, over the bar portion 206, and through the front of the second opening 205. This is shown in FIGS. 4, 5, and 11.

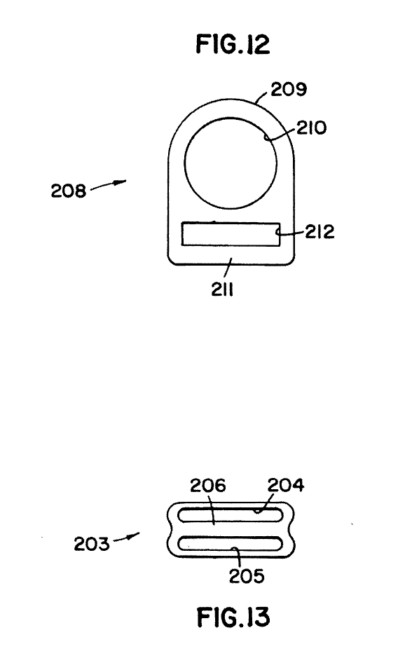

With reference to FIG. 12, the D-ring 208 is also preferably made of steel and includes a ring portion 209 with an aperture 210, a bar portion 211, and an opening 212 between the ring portion 209 and the bar portion 211. Although a harness connector 203 and a D-ring 208 are shown, it is recognized that any suitable connector well known in the art may be used for these elements.

The shock absorbing strap 202 includes a top 214a and a bottom 214b. A first segment 202a and a second segment 202b proximate the top 214a are operatively connected proximate a junction 202d, preferably also proximate the top 214a. At the junction 202d, the segments 202a and 202b are either interwoven, operatively connected by stitching, or otherwise operatively connected by means well known in the art to form an interconnected portion 202c, which extends downward from the junction 202d toward the bottom 214b. In other words, the top 214a includes the first segment 202a and the second segment 202b where the segments of webbing are not operatively connected, and the interconnected portion 202c extends downward toward the bottom 214b from the junction 202d where the segments of webbing are operatively connected.

The first connecting end 201a of the strap 201 is preferably inserted through the second opening 205 of the harness connector 203 and then folded back onto itself so that there are two layers 223a and 223b of webbing below the harness connector 203. The first layer 223a is proximate the end of the first connecting end 201a and is secured with stitching onto the second layer 223b to secure the harness connector 203 to the first connecting end 201a. Preferably, the first layer 223a faces outward. The first segment 202a of the shock absorbing strap 202 is also folded back onto itself so that there are two layers 224a and 224b of webbing, and the two layers 224a and 224b are secured with stitching to the first connecting end 201a with the first layer 224a facing outward toward the second layer 223b of the first connecting end 201a. Alternatively, the first segment 202a may be inserted between the two layers 223a and 223b of webbing, and the two layers 223a and 223b may be secured to secure the harness connector 203 and the first segment 202a thereto.

The second connecting end 201b of the strap 201 is preferably inserted through the opening 212 of the D-ring 208 and then folded back onto itself so that there are two layers 225a and 225b of webbing below the D-ring 208. The first layer 225a is proximate the end of the second connecting end 201b and is secured with stitching onto the second layer 225b to secure the D-ring 208 to the second connecting end 201b. Preferably, the first layer 225a faces outward. The second segment 202b of the shock absorbing strap 202 is also folded back onto itself so that there are two layers 226a and 226b of webbing, and the two layers 226a and 226b are secured with stitching to the second connecting end 201b with the first layer 226a facing outward toward the second layers 225b of the second connecting end 201b. Alternatively, the second segment 202b may be inserted between the two layers 225a and 225b of webbing, and the two layers 225a and 225b may be secured to secure the D-ring 208 and the second segment 202b thereto.

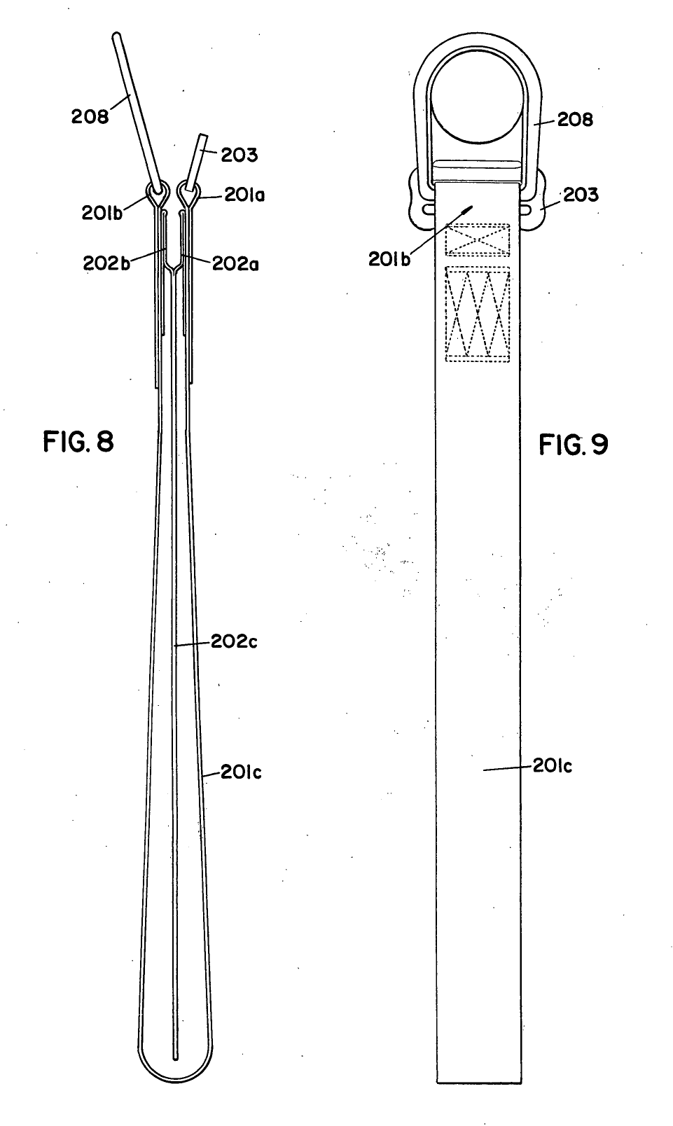

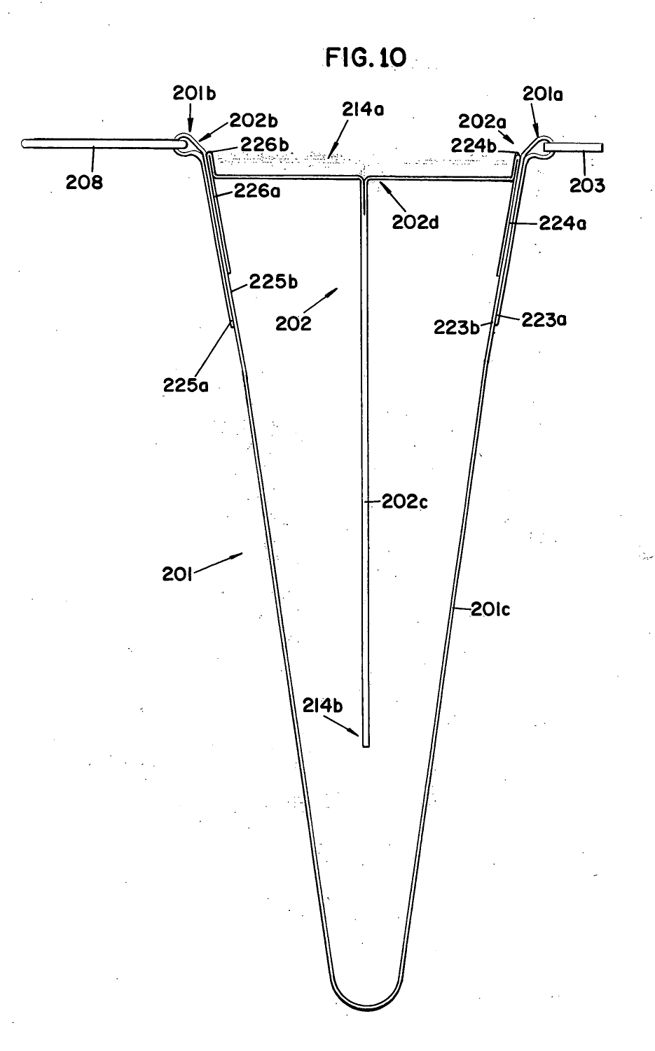

When operatively connected to the safety harness 300, the strap 201 and the shock absorbing strap 202 preferably both extend in a downward direction from the harness connector 203 and the D-ring 208. The strap 201 is preferably one piece of webbing with the intermediate portion 201c extending between the first end 201a and the second end 201b and forming a loop proximate the end of the shock absorber 200 opposite the harness connector 203 and the D-ring 208. In other words, the intermediate portion 201c forms two layers of webbing between the loop at the end of the shock absorber 200 and the ends 201a and 201b. Proximate the segments 202a and 202b of the shock absorbing strap 202, the interconnected portion 202c is positioned between the two layers of the intermediate portion 201c between the loop formed by the intermediate portion 201c and the ends 201a and 201b. In other words, the interconnected portion 202c of the shock absorbing strap 202 is positioned inside the two layers of the intermediate portion 201c of the strap 201. The folded portions of the connecting ends 201a and 201b and the segments 202a and 202b preferably face an outward direction away from the interconnected portion 202c. This is shown in FIGS. 8 and 10.

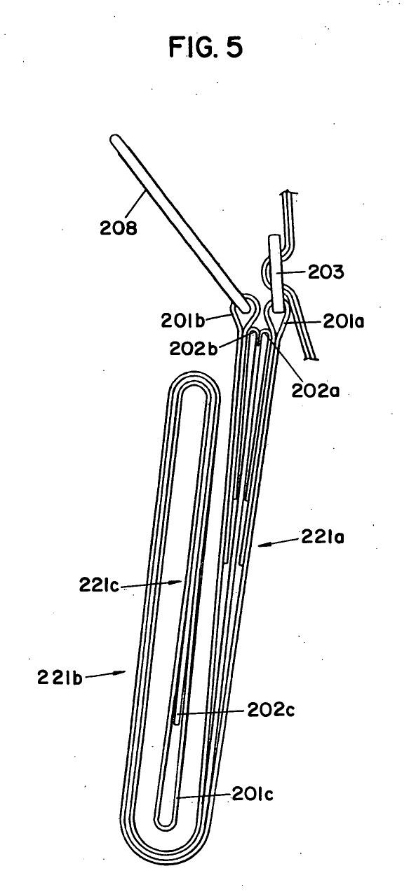

To utilize the releasable sleeve 216, starting with the straps 201 and 202 extending downward from the harness connector 203 and the D-ring 208, as shown in FIGS. 8 and 9, the straps 201 and 202 are folded into thirds forming three portions 221a, 221b, and 221c, as shown in FIG. 5. When unfolded, the first portion 221a is proximate the top, the second portion 221b is proximate the middle, and the third portion 221c is proximate the bottom. The third portion 221c is first folded upward and placed adjacent the second portion 221b, and then the second portion 221b and the third portion 221c are folded upward and placed adjacent the first portion 221a. When folded, the first portion 221a is proximate the right side, the second portion 221b is proximate the left side, and the third portion 221c is proximate the middle. The folded straps 201 and 202 are then inserted into the releasable sleeve 216, which keeps the straps 201 and 202 in a more compact arrangement.

The releasable sleeve 216 is preferably made of a nylon material and remains in place and covers/protects the straps 201 and 202. When subjected to the force of a fall, the sleeve 216 allows the straps 201 and 202 to be pulled from the sleeve 216 for operation. The sleeve 216 does not interfere with the operation of the straps 201 and 202 should a fall occur. As shown in FIG. 6, the sleeve 216 includes a body 218 configured and arranged to house the folded straps 201 and 202. A neck 217 proximate the top of the body 218 may be cinched around the second end 201b to prevent the second end 201b from getting twisted with the first end 201a. A connecting member 219 may be used to operatively connect the bottom of the body 218 to the connector strap 304 of the safety harness 300. Preferably, the connecting member 219 includes a first member 219a and a second member second member 219b, which are pieces of material that wrap around the connector strap 304 and operatively connect to one another with a fastener such as hook and loop to secure the bottom of the body 218 to the connector strap 304.

In operation, the harness connector 203 interconnects the shoulder straps 301 and 302 of the safety harness 300 and the first end 201a of the strap 201 of the shock absorber 200. Because the interconnected portion 202c positions the ends 201a and 201b proximate one another at the top of the shock absorber 200, the D-ring 208 of the shock absorber 200 is positioned proximate the harness connector 203. The straps 201 and 202 extending below the harness connector 203 and the D-ring 208 are folded into thirds to be positioned in a more compact arrangement and housed within the sleeve 216. The safety harness 300 is donned by a user, and the user connects the D-ring 208 to an anchorage point with a lifeline as is well known in the art. Should the user be subjected to a fall, forces will be exerted upon the harness connector 203 and the D-ring 208 thereby unfolding the straps 201 and 202 and causing the interconnected portion 202c to separate and absorb some of the shock of the fall. The sleeve 216 does not interfere with the operation of the shock absorber 200 as the straps 201 and 202 are pulled from the sleeve 216. Should the interconnected portion 202c of the shock absorbing strap 202 become fully separated, the strap 201 acts as a backup strap to ensure the user does not become disconnected from the anchorage point. Alternatively, if one strap is used instead of straps 201 and 202, the one strap separates but does not separate fully to ensure the user does not become disconnected from the anchorage point.

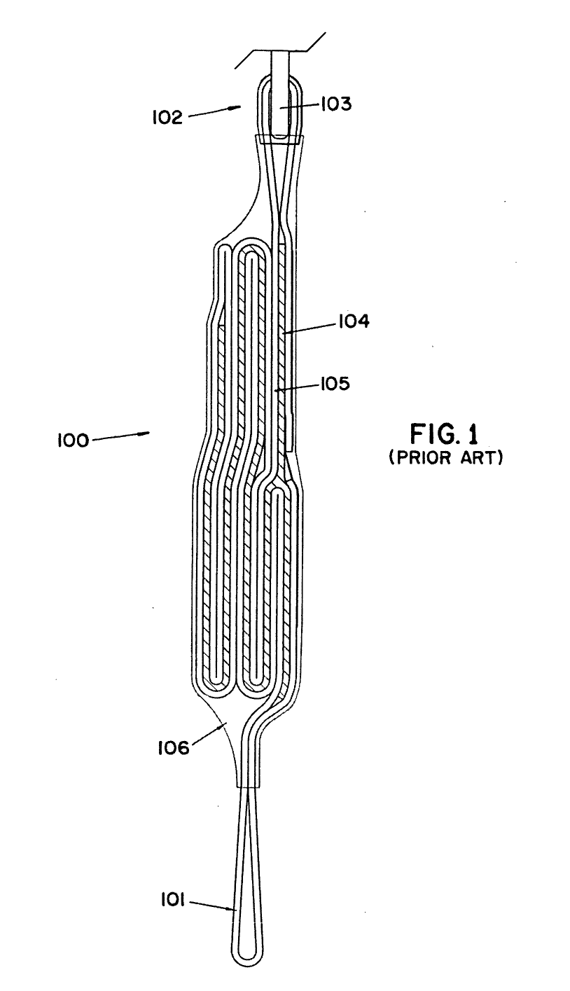

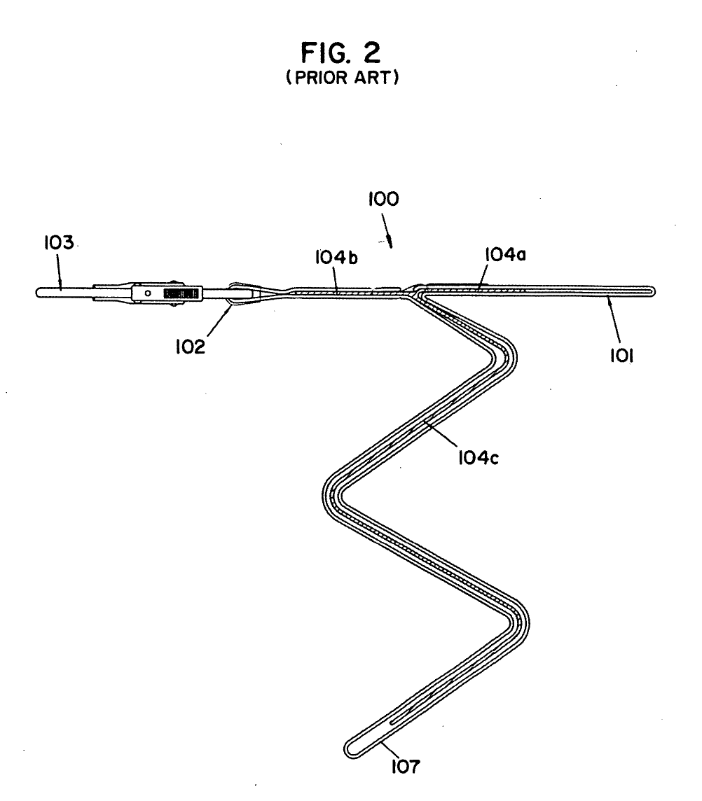

A typical prior art shock absorber 100 is shown in FIGS. 1 and 2. The shock absorber 100 includes a shock absorbing strap 104 made of a webbing material, a strap 105 also made of a webbing material, and a releasable sleeve 106 in which the straps 104 and 105 are folded and stored. The strap 104 includes a first end 104a, a second end 104b, and an interconnected portion 104c. The strap 105 includes a first connecting end 101, a second connecting end 102, and an intermediate portion 107. The first connecting end 101 is folded back onto itself so that there are two layers of webbing, the first end 104a is inserted between the two layers of webbing, and the end of the first connecting end 101 is secured to secure the first end 104a and form a loop between the two layers of webbing. The second connecting end 102 is inserted through a slot in a snap hook 103 and then folded back onto itself so that there are two layers of webbing, the second end 104b is inserted between the two layers of webbing, and the end of the second connecting end 102 is secured to secure the second end 104b and form a loop between the two layers of webbing. Proximate the first connecting end 101 and the second connecting end 102, the first end 104a and the second end 104b of the strap 104 are preferably interwoven or sewn together with stitching thereby forming the interconnected portion 104c corresponding with the intermediate portion 107.

The connecting ends 101 and 102 are separated so that they are on opposite ends of the shock absorber 100, and the interconnected portion 104c and the intermediate portion 107 are then folded in a zig-zag arrangement between the connecting ends 101 and 102, as shown in FIG. 2. The sleeve 106 keeps the straps 104 and 105 thus folded, as shown in FIG. 1. When subjected to the forces of a fall, the opposing ends are pulled and, preferably, the interwoven fibers or the stitching of the interconnected portion 104c are torn thereby separating the first end 104a and the second end 104b when subjected to a fall, which reduces the arresting forces of the fall. The shock absorber 100 preferably helps keep the fall arresting forces under 900 pounds. The strap 104 arrests the fall, and the strap 105 stops the fall should the strap 104 become fully separated. Other prior art shock absorbers are disclosed in U.S. Pat. Nos. 4,538,702 and 5,174,410.

Typically the shock absorber, which may or may not be incorporated into a lanyard, is a separate element of a personal fall arrest system also including a safety harness having a D-ring incorporated into a dorsal back pad of the safety harness. As compared to the prior art shock absorbers, the shock absorber 200 of the present invention has many advantages. One such advantage is how the straps 201 and 202 are configured and arranged to allow the harness connector 203 and the D-ring 208 to be positioned proximate one another at the same end of the device rather than at opposing ends as in the prior art. This also assists in incorporating the shock absorber 200 into the safety harness 300. Another advantage is that the shock absorber 200 also acts as a fall indicator to provide a readily apparent visual indication when the safety harness 300 has been subjected to a load such as a fall and should be discarded. Another benefit is if used with a safety harness of the type disclosed in U.S. patent application Ser. No. 10/819,035, although operatively connected to the shoulder straps of the safety harness, it may be releasably secured to the back pad assembly of the removable padding to allow for the removable padding to be removed from the safety harness. There are many additional benefits recognized by those skilled in the art.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A shock absorbing device, comprising:
a) a safety harness having shoulder straps;
b) a first strap having a first connecting end, a second connecting end, and an intermediate portion, the first connecting end and the second connecting end being at opposite ends of the first strap with the intermediate portion between the first connecting end and the second connecting end;
c) a second strap having a first segment, a second segment, and an interconnected portion, the first segment and the second segment being at one end of the second strap and the interconnected portion extending toward an opposite end of the second strap, the first segment being operatively connected to the first strap proximate the first connecting end, the second segment being operatively connected to the first strap proximate the second connecting end, wherein the first connecting end and the second connecting end are positioned proximate the one end and the intermediate portion extends toward the opposite end;
d) a first connector operatively connected to the shoulder straps and to the first connecting end thereby interconnecting the safety harness and the first strap; and
e) a second connector operatively connected to the second connecting end, wherein the first connector and the second connector are positioned proximate the one end and the intermediate portion and the interconnected portion extend in a downward direction therefrom.

2. The shock absorbing device of claim 1, further comprising a releasable sleeve, wherein the first strap and the second strap are folded to fit within the releasable sleeve in a more compact arrangement.

3. The shock absorbing device of claim 1, wherein the first connector is a harness connector and the shoulder straps criss-cross and overlap in a divergent fashion at a junction, the harness connector engaging the shoulder straps at the junction.

4. The shock absorbing device of claim 1, wherein the second connector is a D-ring.

5. A shock absorber operatively connected to shoulder straps of a safety harness, comprising:
a) a first strap having a first connecting end, a second connecting end, and an intermediate portion, the first connecting end and the second connecting end being at opposite ends of the first strap with the intermediate portion between the first connecting end and the second connecting end;
b) a second strap having a first segment, a second segment, and an interconnected portion, the first segment and the second segment being at one end of the second strap and the interconnected portion extending toward an opposite end of the second strap, the first segment being operatively connected to the first strap proximate the first connecting end, the second segment being operatively connected to the first strap proximate the second connecting end, wherein the first connecting end and the second connecting end are positioned proximate the one end and the intermediate portion extends toward the opposite end;
c) a harness connector operatively connected to the shoulder straps and to the first connecting end thereby interconnecting the safety harness and the first strap; and
d) a D-ring operatively connected to the second connecting end, wherein the harness connector and the D-ring are positioned proximate the one end and the intermediate portion and the interconnected portion extend in a downward direction relative to the harness connector and the D-ring.

6. The shock absorber of claim 5, further comprising a releasable sleeve, wherein the first strap and the second strap are folded to fit within the releasable sleeve in a compact arrangement.

7. A dorsal D-ring shock absorber assembly for use with a safety harness, the safety harness having shoulder straps criss-crossing and overlapping in divergent fashion at a junction proximate a back of the safety harness, comprising:
a) a shock absorber having a first strap and a second strap, the first strap having a first connecting end, a second connecting end, and an intermediate portion, the first connecting end and the second connecting end being at opposite ends of the first strap with the intermediate portion between the first connecting end and the second connecting end, the second strap having a first segment, a second segment, and an interconnected portion, the first segment and the second segment being at one end of the second strap and the interconnected portion extending toward an opposite end of the second strap, the first segment being operatively connected to the first strap proximate the first connecting end, the second segment being operatively connected to the first strap proximate the second connecting end, wherein the first connecting end and the second connecting end are positioned proximate the one end and the intermediate portion extends toward the opposite end;
b) a harness connector operatively connected to the shoulder straps proximate the junction and to the first connecting end thereby interconnecting the safety harness and the first strap; and
c) a dorsal D-ring operatively connected to the second connecting end, wherein the harness connector and the D-ring are positioned proximate the one end and the intermediate portion and the interconnected portion extend in a downward direction relative to the harness connector and the D-ring.

8. The dorsal D-ring shock absorber assembly of claim 7, further comprising a sleeve in which the first strap and the second strap are housed, the first strap and the second strap being folded in a more compact arrangement within the sleeve.

9. A shock absorbing device, comprising:
a) a safety harness having shoulder straps;
b) a strap having a first connecting end, a second connecting end, and an interconnected portion, the first connecting end and the second connecting end being proximate one end of the strap and the interconnected portion extending toward an opposite end of the strap;
c) a first connector operatively connected to the shoulder straps and to the first connecting end thereby interconnecting the safety harness and the strap; and
d) a second connector operatively connected to the second connecting end, wherein the first connector and the second connector are positioned proximate the one end and the interconnected portion extends in a downward direction therefrom.
